(19) United States
(12) Patent Application Publication
(10) Pub. No.: US 2008/0013409 A1
(43) Pub. Date: Jan. 17, 2008

(54) Timepiece with overlapping, separately driven analog and mechanical functionality

(76) Inventors: Diarmuid John St. Cullom Bland, Basel (CH); John Chan Chin Pang, Kowloon (HK); Wallace Fong Wa Ngok, Hong Kong (HK); Luk Kwok Wah, Kowloon (HK); Gregory B. Thumm, Coppell, TX (US)

Correspondence Address: FISH & RICHARDSON P.C., P.O. BOX 1022, MINNEAPOLIS, MN, 55440-1022, US

(21) Appl. No.: 11/484,277

(22) Filed: Jul. 11, 2006

(51) Int. Cl. G04B 19/00; G04C 17/00; G04B 25/00

(52) U.S. Cl. 368/223

(57) ABSTRACT

A dual-powered timepiece for independently displaying time information and driving one or more other timepiece functions comprises a case comprising a case interior and a case opening substantially defined by a periphery of a first side of the case. The timepiece further includes an analog movement comprising a first timing device within the case interior, where the analog movement drives the display of time information in hours and minutes. Also, the timepiece may comprise a lever escapement mechanism comprising a second timing device within the case interior. This level escapement mechanism is substantially independent from the analog watch movement and drives at least one timepiece function.

### TECHNICAL FIELD

The present disclosure involves timepieces and, more particularly, timepieces with overlapping, separately driven analog and mechanical functionality.

### BACKGROUND

Watches, clocks, and other timekeeping devices have one or more components for measuring and displaying time (such as hours and minutes) and may come in various sizes and shapes. For example, watches are typically considered portable clocks that may be worn on the wrist, carried in a pocket or on a chain, and so forth. Most analog watches are one of three types: mechanical, electromechanical, and quartz. Mechanical watches are usually powered by a spring that may be wound by the wearer or may be self-winding. Electromechanical watches include a battery or other similar power source that essentially replaces the spring. Quartz watches use a quartz crystal that, when combined with an analog movement, drives the display using electricity. Other watches may be considered digital watches, which indicate that the watches are electronic and have electro-optical displays. Each of the watch types may display other information or include other functionality including, for example, a calendar or date, a seconds indicator, alarms, and so forth.

### SUMMARY

In one aspect, a dual-powered timepiece for independently displaying time information and driving one or more other timepiece functions comprises a case comprising a case interior and a case opening substantially defined by a periphery of a first side of the case. The timepiece further includes an analog movement comprising a first timing device within the case interior, where the analog movement drives the display of time information in hours and minutes. Also, the timepiece may comprise a lever escapement mechanism comprising a second timing device within the case interior. This level escapement mechanism is substantially independent from the analog watch movement and drives at least one timepiece function—other than the display of time information.

The details of one or more embodiments of the invention are set forth in the accompanying drawings and the description below. Other features, objects, and advantages of the invention will be apparent from the description and drawings, as well as from the claims.

### DESCRIPTION OF DRAWINGS

FIG. 1 is a front view of an illustrative timepiece constructed in accordance with one embodiment of the present disclosure;

FIG. 2A is a front view of the movement of the illustrative timepiece of FIG. 1;

FIG. 2B is a back view of the movement of the illustrative timepiece of FIG. 1;

FIG. 2C is a front view of the movement of the illustrative timepiece of FIG. 1; and

FIGS. 3A-C are front views of example dual-powered timepieces constructed in accordance with the present disclosure.

### DETAILED DESCRIPTION

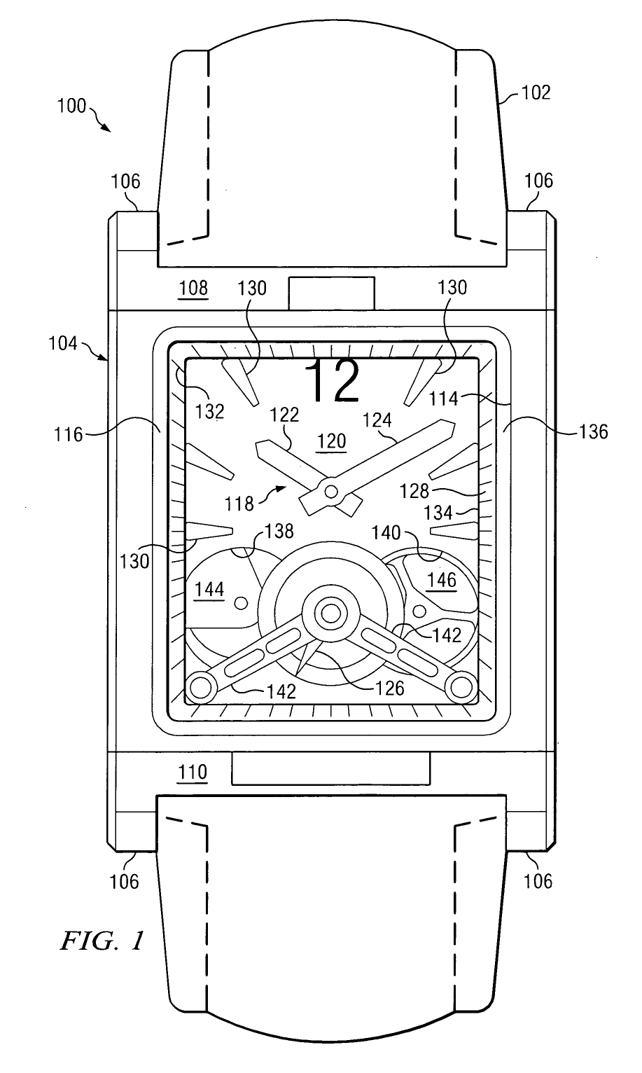

FIG. 1 illustrates an example dual-powered timepiece 100 that displays time information using one power source and independently drives one or more other timepiece functions using a second power source. Generally, timepiece 100 implements analog movement (such as quartz) and mechanical power sources that can be substantially collocated, but that are independent and drive distinct functionality. More specifically, timepiece 100 may be powered by a battery driven, quartz integrated circuit that is integrated with—but independent from—a mainspring driven, balance wheel regulated, lever escapement mechanism in certain cases. Timepiece 100 may take the form of any timekeeping device including a wristwatch, a pocketwatch, or other type of clock, watch, or chronometer. Such independent dual-power may allow a watch that is simpler to design, as well as less expensive to manufacture and purchase. Indeed, such timepieces 100 may allow a manufacturer to make or a vendor to sell watches that look mechanical, but with much of the functionality powered by (typically less expensive and more accurate) analog movement.

Turning to FIG. 1, the illustrated timepiece 100 comprises a wristwatch, which includes a strap 102 and a case 104. The case 104 may be substantially rectangular (as illustrated), circular, square, octagonal, oval, irregular shaped, or any other appropriate or desired shape. A plurality of outwardly extending protrusions may form one or more lugs 106. The lugs 106 may be arranged singly or in pairs, located on opposing sides of the case 104, and shaped so as to be rounded, teardrop, hidden, or other. In the illustrated example, the lugs 106 are arranged in pairs and are located proximal to a top portion 108 and a bottom portion 110 of the case 104.

The case 104 includes a case interior 112 and a case opening 114 substantially defined by a periphery of a first side 116 of the case 104. The case 104 is configured to receive a movement 118, a face 120, and two or more hands, disks, or other indicators, such as the three shown: 122, 124, and 126. As generally described above, the movement 118 is dual powered that allows for the display of time information, such as hours and minutes, and the independent driving of one or more other timepiece functions, such as the display of seconds, sub-seconds, date, alarm time, or others. Particularly, portions of movement 118 are independently powered by a quartz timing device and a mechanical timing device.

The case 104 may include a bezel 128 that is symmetrically aligned with the case opening 114. In the embodiment of FIG. 1, the bezel 128 is an interior type bezel that is integrally formed with the case. In an alternate embodiment (not shown), the bezel 128 can be an exterior type bezel and may be removably attached to the case, rotatably attached to the case, or both. Further, the bezel 128 may include a plurality of markings that facilitate the reading of time information indicated by the position of an hour indicator 122 and a minute indicator 124. The markings can include Roman, Arabic, or other alphanumeric characters or symbols alone or combined with segments, dots, or other markings or indications. In some cases, the markings may have a luminescent coating such as, for example, radium, tritium, or Luminova, that can facilitate the reading of time information in the dark.

The illustrated markings on the bezel 128 in the current embodiment include a plurality of long segments 130 and a plurality of short segments 132 that display time information. The long segments 130 can be radially dispersed on the bezel 128, for example, at approximately 15 degree intervals to indicate each of the positions of each of the twelve hours on the bezel 128. In another example, the long segments can be radially dispersed on the bezel 128 at approximately 90 degree intervals to indicate the three, six, nine, and twelve o'clock positions. The short segments 132 can be radially dispersed on the bezel 128 between the long segments 130, for example, at approximately three degree intervals to indicate the minute positions on the bezel 128.

Additionally, the bezel 128 defines an aperture 134 through which the face 120 of the timepiece 100 can be viewed. In the current embodiment, the shape of the aperture 134 is substantially rectangular. However, it should be noted that the aperture 134 can be alternately shaped. For example, the aperture 130 can be substantially circular, square, octagonal, oval, irregular, or other. The bezel 128 carries a transparent cover 136 that is coupled to the case 104 and the transparent cover 136 covers the aperture 134 and the case opening 114. In the current embodiment, the transparent cover 136 is comprised of a transparent crystal material, for example, glass, acrylic, mineral glass, sapphire, or other.

The face 120 resides proximal and substantially adjacent to the movement 118 and the face 120 may define one or more openings through which one or more components of the movement 118 located substantially behind the face 120 can be viewed. Typically, this allows the viewer (whether the wearer or not) to see mechanical components within the watch face. For example, an opening can display a lever escapement mechanism, an oscillating weight, a hair wheel, or other. Additionally, in a configuration where the face 120 includes an opening, one or more supports may extend from the face 120 to the case such that the face 120 is supported in relation to the case 104. In the illustrated example, the face 120 includes two openings 138 and 140 and a pair of supports 142 through which substantial portions of a lever escapement mechanism can be viewed. In this example, a hair wheel 144 and a barrel 146 can be viewed. Additionally, the backside of the case 104 (not shown) includes a case back that covers the backside of the case, and the case back may include an opening through which substantial portions of the movement may be viewed, for example, the winding rotor.

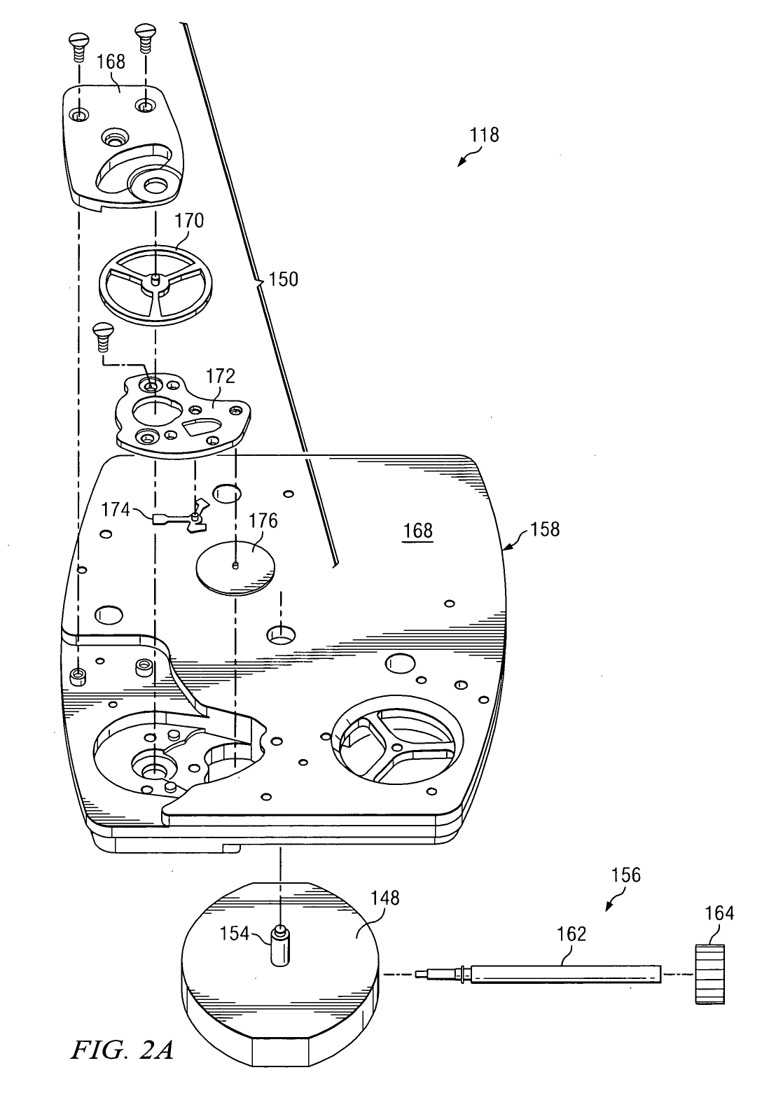

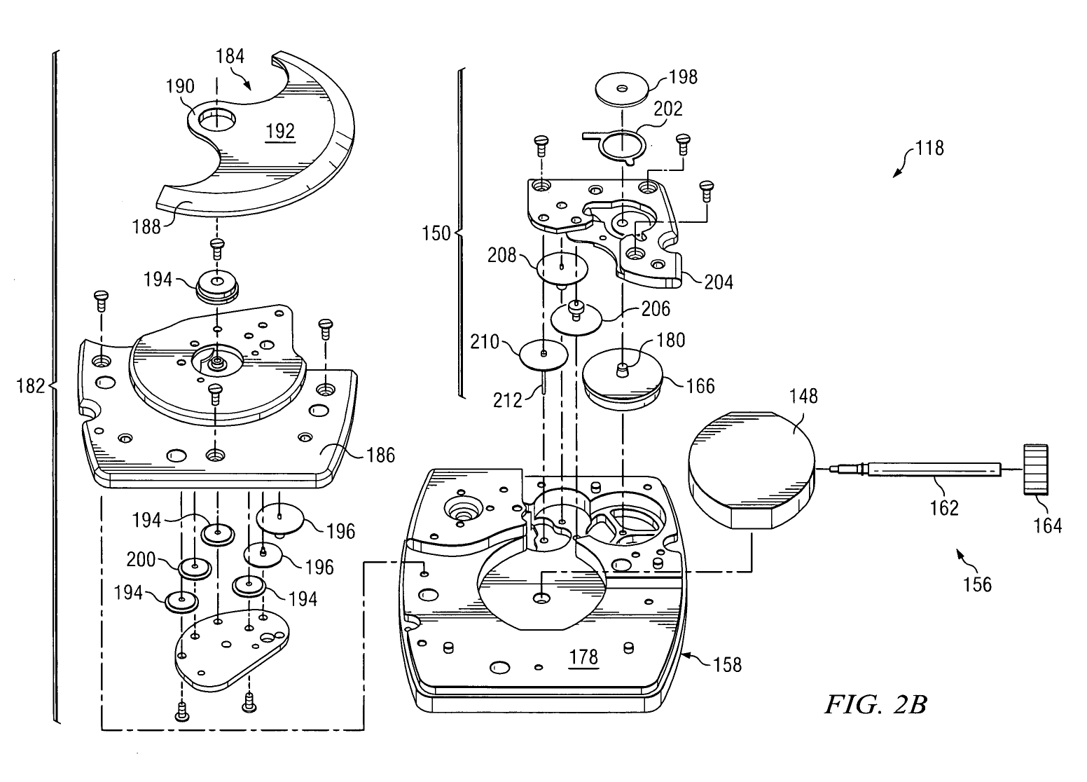

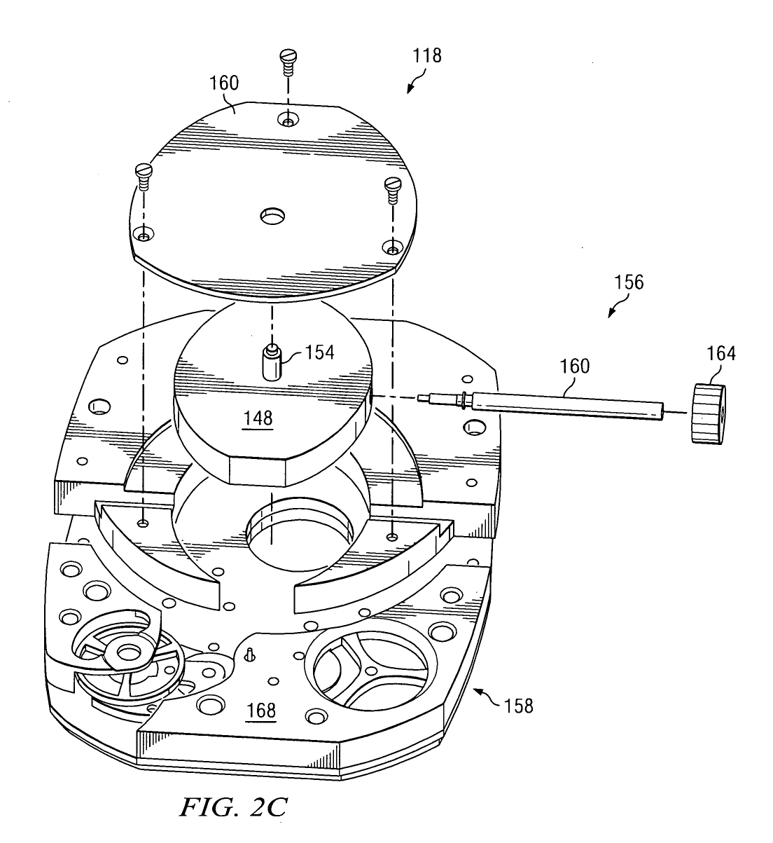

FIGS. 2A, 2B, and 2C illustrate a front view (FIGS. 2A and 2C), and a back view (FIG. 2B) of the movement 118. The dual-power of the movement 118 includes an analog watch movement 148 and a lever escapement mechanism 150. The analog watch movement 148 comprises a first timing device that is disposed substantially within the case interior 112. This analog watch movement 148 drives the display of time information in hours and minutes. The lever escapement mechanism 150 comprises a second timing device that is disposed substantially within the case interior 112, is substantially independent from the analog watch movement 148, and drives at least one of the functions of the timepiece 100. The analog movement 148 of the timepiece 100 may be at least partially hidden by the lever escapement mechanism 150. Further, the timepiece 100 includes an analog display comprising the face 120, the hour hand 122, the minute hand 124, and the bezel 128. Additionally, the analog movement 148 may include a quartz crystal and battery, a hand-moving assembly 154 and a stem and crown assembly 156, or some other self-contained, battery-powered, electronic analog watch movement or analog timing circuit. The hand-moving assembly 154 extends from the analog movement 148 through the lever escapement mechanism 150, and couples to the hour hand 122 and the minute hand 124 of the analog display.

In the current embodiment of FIGS. 2A, 2B, and 2C, the analog watch movement 148 of the timepiece 100 drives the display of time information. The driving of the time information comprises the analog watch movement 148 coupled to a first end of the hand-moving assembly 154 and the hand-moving assembly is coupled at a second end to the hour hand 122 and the minute hand 124. The analog watch movement 148 thereby drives the hour hand 122 and the minute hand 124 to display a time of day in hours and minutes, respectively. In another embodiment (not shown), the analog watch movement 148 may drive the display of time information using the analog watch movement 148 coupled to a first end of the hand-moving assembly 154 and the hand-moving assembly coupled at a second end to an hour disk and a minute disk. The analog watch movement 148 thereby drives the hour disk and the minute disk to display a time of day in hours and minutes, respectively.

FIGS. 2A and 2B display the example lever escapement movement 150 portion of the movement 118 comprising a mainspring driven, balance wheel regulated lever escapement mechanism. The escapement in a mechanical timepiece, such as the timepiece 100 in the current embodiment, refers to a combination of parts that include an anchor, pallets, and a balance wheel amongst others. The combination of parts that comprise the escapement translate the power of the escapement mechanism into regular timekeeping, and are responsible for the familiar ticking sound commonly associated with a mechanical timepiece.

FIG. 2A illustrates portions of the lever escapement movement 150 removably coupled to the front portion 168 of the main plate 158. The portions of the lever escapement movement 150 illustrated include a roller plate 168, a balance (with hair) wheel 170, an escape plate 172, a pallet fork 174, and an escape wheel 176. The pallet fork 174 is an integral component of the lever escapement movement 150, and interacts with the escape wheel 176 and the balance wheel 170.

FIG. 2B illustrates portions of the lever escapement movement 150 removably coupled to the rear portion 178 of the main plate 158. While not shown, the lever escapement mechanism 150 is powered by energy stored in a mainspring located in a barrel 166. The mainspring is wound by turning a winding post 180 that protrudes outwardly from the barrel 166. A self winding automatic device 182 is mounted to the rear portion 178 of the main plate 158. The automatic device includes a winding rotor 184 that is mounted to a framework 186 such that movement of the timepiece 100 causes the winding rotor 184 to rotate in the case 104 and turn the winding post 180. Movement of the winding rotor 184 is caused both by inertial forces from the timepiece 100 being moved, as well as gravitational forces acting on the winding rotor 184 as the orientation of the timepiece 100 changes.

The winding rotor 184 includes an arcuate outer portion 188, a flange 190, and a web 192 that spans the outer portion 188 and the flange 190. The flange 190 is adapted to rotatably couple to the framework 186 to mount the winding rotor 184 to the movement 118. The outer portion 188 may have a thickness (and thus weight) that is greater than the web 192, thereby increasing the mass moment of inertia of the winding rotor 184 with less of an increase in the overall weight of the winding rotor 184. In other words, the additional weight more efficiently adds to the mass moment of inertia than if it were added throughout the winding rotor 184.

The winding rotor 184 is rotatably coupled by the automatic device 182 to the winding post 180 of the barrel 166 by a series of gears, pinions, and wheels typically referred to as the train. The gears, pinions, and wheels that connect the winding rotor 184 to the barrel 166 of the lever escapement mechanism 150 include a plurality of reduction wheels 194, a plurality of connecting wheels 196, ratchet wheel 198, a driving gear 200 for the ratchet wheel 198, and a fixing metal piece 202.

Still referring to FIG. 2B, the barrel 166 of the lever escapement mechanism 150 is removably installed between a wheel plate 204 and the main plate 158. The barrel 166 is typically a cylindrical box (i.e., barrel) with a toothed disc (i.e., wheel) located on the outer edge of the barrel 166. The toothed disc is generally referred to as the great wheel and the cylindrical box portion of the barrel 166 contains the mainspring. In typical operation, the cylindrical box rotates about its arbor (i.e., winding post 180), and the mainspring is hooked to the cylindrical box at its outer end and to the arbor at its inner end. The great wheel meshes so as to be rotatably coupled with a first pinion or intermediate wheel 206 of the watch train. The intermediate wheel 206 meshes so as to be rotatably coupled with a connect wheel 208 and a second wheel 210. The second wheel 210 includes a shaft 212 to which the second timing function of the timepiece 100 is connected, for example, a second hand, a date indicator, or other. Additionally, the second wheel 210 meshes so as to be rotatably coupled to the balance wheel 170 and the pallet fork 174.

The illustrated function of the timepiece 100 that is driven by this lever escapement mechanism 150 comprises the time information of seconds. The time information of seconds is displayed by a second hand 126 on the lower portion of the face 120 proximal to the openings 144 and 146. Alternately, the lever escapement mechanism 150 can drive the display of second information that comprises the lever escapement mechanism 150 driving a sub-second hand (not shown) that displays a portion of a second. In other alternative or complementary embodiments, this mechanical movement may drive other suitable timepiece functions including, for example, calendar or date, alarm, and so forth.

FIG. 2C illustrates an example front view of the movement 118. The case 104 is configured to accommodate the analog watch movement 148 and the stem and crown assembly 156. The analog movement 148 and the stem and crown assembly 156 are removably installed between a main plate 158 and a mounting plate 160, while the main plate 158 is configured to fit within the cavity defined by the case interior 112.

In this example, the analog watch movement 148 comprises a quartz movement that includes a battery driven, quartz integrated circuit. A quartz movement is a watch powered by an oscillating quartz crystal that draws its power from a small battery, for example, a litho battery. The quartz crystal typically oscillates 32,768 times per second and the electronic integrated circuit divides the oscillation into substantially precise increments of 1 second or less. Example quartz movements include the Ronda 751 Quartz movement, the Citizen Quartz movement, or other readily available quartz movements.

The stem and crown assembly 156 includes a crown shaft 162 and a crown 164. The crown shaft 162 is coupled at a first end to the analog movement 148, may extend outward from a side of the analog watch movement 148, and through the mounting plate 158. The second end of the crown shaft 162 extends through a sidewall of the case 104 and couples to the crown 164. The stem and crown assembly 156 may be used to wind the timepiece 100, to set the correct time, to set the date, or other. Additionally, the crown 164 may be a screw type crown that screws tightly to the case 104 such that the crown 164 attaches to a tube, thereby ensuring that the timepiece 100 may be substantially resistant to water.

The battery and the quartz integrated circuit may further supply power to (or drive) a source of backlighting, a digital display, other suitable display components, or combinations thereof. For example, the timepiece 100 may include an Electro-luminescent (EL) backlight, a Liquid Crystal Display (LCD) that may act as a backlight as well as display, an Organic Light Emitting Device (OLED) display, or other.

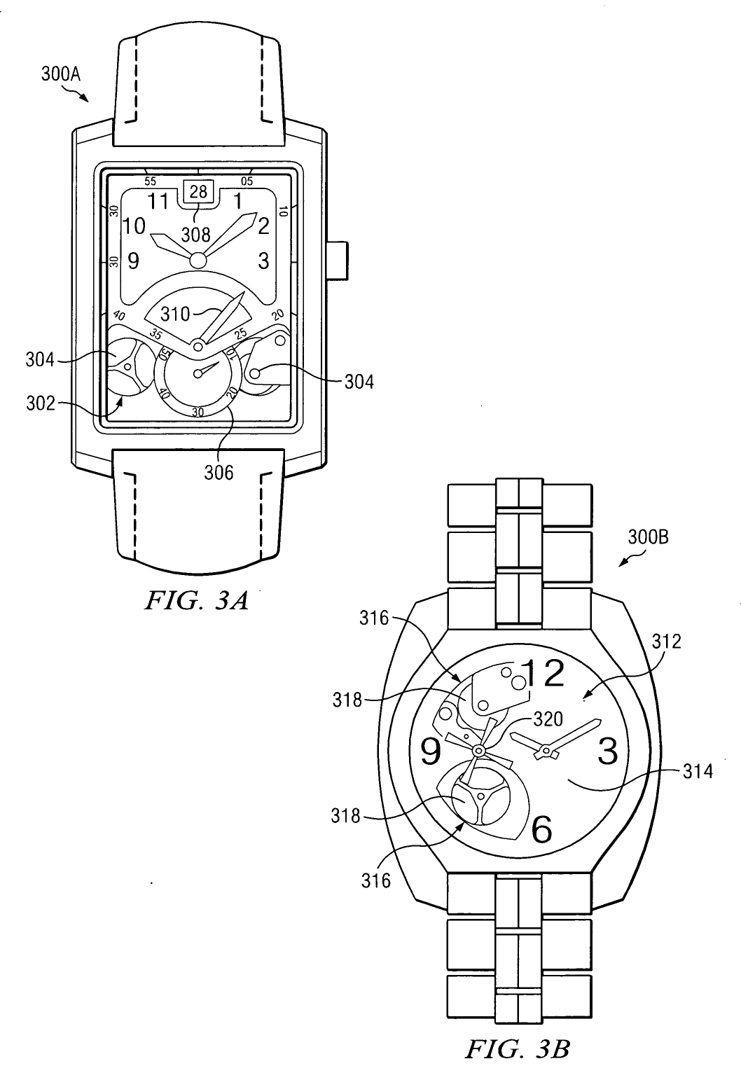

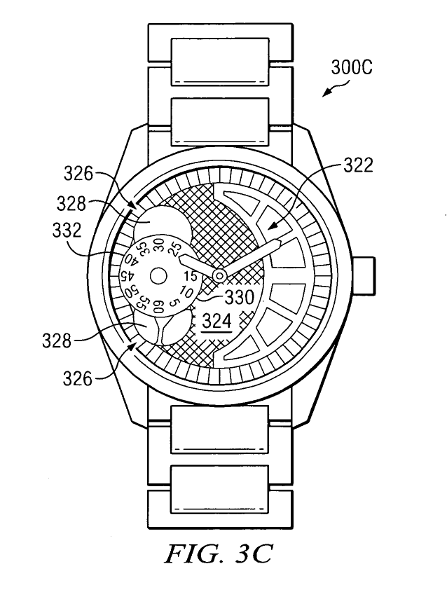

FIGS. 3A, 3B, and 3C illustrate a number of examples of timepieces (300A, 300B, and 300C) that include the previously described independent dual-powered movement. The timepieces 300A, 300B, and 300C include a lever escapement mechanism that drives at least one of the functions of the timepieces 300A, 300B, and 300C. The timepiece 300A includes an opening 302 through which a lever escapement mechanism 304 and/or some other active mechanical components can be partially viewed. The lever escapement mechanism 304 drives a second hand display function 306, a date dial 308, and a twenty-four hour display function 310. The twenty-four hour display function 310 can include alarm time information and functionality, military time information and functionality, or both.

The timepiece 300B includes a decorative display face 312 that includes a graphic configured to resemble an airplane 314. Additionally, the timepiece 300B includes an opening 316 through which a lever escapement mechanism 318 can be partially viewed. In this case, the lever escapement mechanism 318 drives the second hand, which is configured to resemble an airplane propeller 320. Alternate configurations of a decorative timepiece face and second hand may include, for example, a bicycle and a bicycle wheel, a record player and a record, a car with a grill through which an escapement mechanism can viewed, and many others.

The timepiece 300C includes a decorative display face 322 a portion of which includes a pattern 324 that resembles a carbon fiber weave. The face includes an opening 326 through which an escapement mechanism 328 can be partially viewed. The escapement mechanism 328 drives a substantially circular and substantially transparent disk 330 that is configured to rotate so as to display the time information of seconds. The disk 330 includes numeric characters 332 radially dispersed at approximately 30 degree intervals to indicate the five, ten, fifteen, twenty, twenty-five, thirty, thirty-five, forty, forty-five, fifty, fifty-five, and sixty second positions.

A number of embodiments of the invention have been described. Nevertheless, it will be understood that various modifications may be made without departing from the spirit and scope of the invention. Accordingly, other embodiments are within the scope of the following claims.

What is claimed is:

1. A dual-powered timepiece for independently displaying time information and driving one or more other timepiece functions, the timepiece comprising:
a case comprising a case interior and a case opening substantially defined by a periphery of a first side of the case;
an analog movement comprising a first timing device within the case interior, the analog movement driving the display of time information in hours and minutes; and
a lever escapement mechanism comprising a second timing device within the case interior, the level escapement mechanism substantially independent from the analog watch movement and driving at least one timepiece function.

2. The timepiece of claim 1, the lever escapement mechanism comprising a mainspring driven, balance wheel regulated, lever escapement mechanism.

3. The timepiece of claim 1, at least one of the timepiece functions driven by the lever escapement mechanism comprising display of time information in seconds.

4. The timepiece of claim 3, the lever escapement mechanism driving the display of second information comprising the lever escapement mechanism driving a sub-second hand that displays a portion of a second.

5. The timepiece of claim 1, at least one of the timepiece functions driven by the lever escapement mechanism comprising display of date information.

6. The timepiece of claim 5, the lever escapement mechanism driving the display of date information comprising the lever escapement mechanism driving at least one date dial.

7. The timepiece of claim 1, at least one of the timepiece functions driven by the lever escapement mechanism comprising display of alarm time information.

8. The timepiece of claim 1, the lever escapement mechanism being substantially viewable through the case opening.

9. The timepiece of claim 1, a transparent crystal coupled to the case and covering the case opening.

10. The timepiece of claim 1, the case configured to accommodate quartz movement as the analog movement.

11. The timepiece of claim 10, the analog movement comprising a battery driven, quartz integrated circuit.

12. The timepiece of claim 11, the battery comprising a litho battery.

13. The timepiece of claim 11, the quartz integrated circuit further driving an Electro-luminescent (EL) backlight.

14. The timepiece of claim 11, the quartz integrated circuit further driving a Liquid Crystal Display (LCD) display.

15. The timepiece of claim 11, the quartz integrated circuit further driving an Organic Light Emitting Device (OLED) display.

16. The timepiece of claim 1, the analog movement driving the display of time information comprising the analog movement driving an hour hand and a minute hand that display a time of day in hours and minutes respectively.

17. The timepiece of claim 1, the analog movement driving the display of a time information comprising the analog movement driving an hour disk and a minute disk that display a time of day in hours and minutes respectively.

18. The timepiece of claim 1, the analog movement at least partially hidden by the lever escapement mechanism and the timepiece further comprising an analog display comprising an hour hand, a minute hand, and an interior bezel, the interior bezel symmetrically aligned with the case opening and further comprising a plurality of markings that facilitate reading the time information indicated by the position of the hour hand and the minute hand; and
wherein the analog movement comprises a battery, the first timing circuit, a hand-moving assembly, and a stem and crown assembly, the hand-moving assembly extending from the analog movement through the lever escapement mechanism and coupling to the hour hand and the minute hand of the analog display.

19. The timepiece of claim 1, the timepiece comprising a wristwatch.
